(19) United States
(12) Patent Application Publication
(10) Pub. No.: US 2018/0059655 A1
(43) Pub. Date: Mar. 1, 2018

(54) PRODUCTION SYSTEM HAVING FUNCTION OF INDICATING INSPECTION TIME FOR PRODUCTION MACHINE

(71) Applicant: FANUC CORPORATION, Yamanashi (JP)

(72) Inventor: Tsuyoshi HANNYA, Yamanashi (JP)

(21) Appl. No.: 15/683,966

(22) Filed: Aug. 23, 2017

(30) Foreign Application Priority Data
Aug. 30, 2016 (JP) 2016-168200

(51) Int. Cl. G05B 23/02

(52) U.S. Cl. CPC G05B 23/02

(57) ABSTRACT

A production system includes at least one production machine, a machine management device, and a production management device. The production machine transmits cumulative total use time data to the machine management device. The production management device has a transfer part which transfers scheduled production number information, recommended inspection time information, and inspection reservation information. The machine management device has a determination part which determines, based on the cumulative total use time data of each production machine and the recommended inspection time information, whether an inspection is necessary within a predetermined period of time, and an extraction part which extracts a predetermined number of dates from the extracted reservable dates, in order of smallest to largest scheduled production number, based on the inspection reservation information and the scheduled production number information.

### BACKGROUND OF THE INVENTION

### 1. Field of the Invention

The present invention relates to a production system for producing products in a production facility including a plurality of production machines.

### 2. Description of the Related Art

In a production factory, the appropriate arrangement of a plurality of production machines, such as machine tools or robots, constructs production facilities of a line production system or a cell production system, i.e., production lines or production cells. Further, at each production facility, a plurality of different production machines are used to perform assembling, processing, welding, etc. The production machines which constitute each production facility are connected via their control devices. In the meantime, a production management device manages production volume, quality, safety, etc., while acquiring, from each production machine, information regarding the state, operation time, etc. of the production machine in each production facility.

In such production facilities, when production machines such as machine tools or robots do not work properly due to their abnormality, the productivity reduces. In order to obviate such a disadvantage, a periodic inspection is conducted for a production machine, and various methods for supporting a periodic inspection have conventionally been proposed.

For example, Japanese Unexamined Patent Publication No. 2003-178155A discloses a management support system for machinery, which recognizes the time of a periodic inspection for a construction machine, outputs, based on the location information of the construction machine, the nearest inspection institution which can conduct a periodic inspection and schedule of the inspection institution to the computer of the user.

Further, Japanese Unexamined Patent Publication No. 09-305218A discloses a device which recognizes the degree of importance of all instruments, for which the preventive maintenance of a plant is conducted, and schedules a periodic inspection before or after the initial target date of the periodic inspection depending on the degree of importance, so that a long-term preventive maintenance plan is optimized.

In the meantime, periodic inspection items for production machines such as industrial robots may sometimes include replacement of components. In the replacement of components, it is necessary to halt the production machine for a long time. However, if the production machine remains at rest for a long time when the production volume is large, the production opportunity loss would be enormous. Thus, it is demanded to halt the production machine in order to conduct the inspection when the production volume is small.

When an inspection organization is requested to conduct an inspection, it may be difficult for the inspection organization to adjust the schedule thereof if a request is made immediately before the target date of a periodic inspection. However, the possibility that the inspection schedule of the inspection organization can be reliably arranged is increased by making a reservation for the inspection to be conducted by the inspection organization.

As described above, a device that can submit a date, on which a small production volume is planned and which is convenient for the production organization, to the user has been demanded. The technology that can realize this demand is not disclosed or suggested in, for example, Japanese Unexamined Patent Publication No. 2003-178155A or Japanese Unexamined Patent Publication No. 09-305218A.

### SUMMARY OF INVENTION

The present invention provides a production system which can submit a date, on which a small production volume is planned and which is convenient for a production organization, to the user.

According to a first aspect of this disclosure, there is provided a production system including: at least one production machine; a machine management device which is communicably connected to the production machine and manages the production machine; and a production management device which is communicably connected to the machine management device and manages a production status in the production machine. The production machine has a use time measuring part for acquiring, as cumulative total use time data, an elapsed time from the beginning of use of the production machine or a cumulative operation time, and transmitting the same to the machine management device. The production management device has: a storage part which stores scheduled production number information obtained by associating a plurality of consecutive dates with a scheduled production number in each production machine at every date, recommended inspection timing information obtained by associating a plurality of inspection items in each production machine with an inspection time at which an inspection of the inspection items should be conducted, and inspection reservation information obtained by associating a plurality of consecutive dates with a reservable status of an inspection organization at each of these dates; and a transfer part which transfers the scheduled production number information, the recommended inspection timing information, and the inspection reservation information from the storage part to the machine management device. The machine management device has: a determination part which determines, using the cumulative total use time data of each production machine and the recommended inspection time information, whether a grace period until the nearest inspection time remains within a predetermined period of time; and an extraction part which extracts, when the determination part determines that the grace period remains within the predetermined period of time, all dates on which a reservation for an inspection can be made based on the inspection reservation information, and extracts, in order of smallest to largest scheduled production number, a predetermined number of dates from the extracted reservable dates based on the scheduled production number information.

According to a second aspect of this disclosure, there is provided a production system including: at least one production machine; and a production management device which is communicably connected to the production machine and manages a production status in the production machine. The production machine has a use time measuring part for acquiring, as cumulative total use time data, an elapsed time from the beginning of use of the production machine or a cumulative operation time, and transmitting the same to the machine management device. The production management device has: a storage part which stores scheduled production number information obtained by associating a plurality of consecutive dates with a scheduled production number in each production machine at every date, recommended inspection timing information obtained by associating a plurality of inspection items in each production machine with an inspection time at which an inspection of the inspection items should be conducted, and inspection reservation information obtained by associating a plurality of consecutive dates with a reservable status of an inspection organization at each of these dates; a determination part which determines, using the cumulative total use time data of each production machine and the recommended inspection time information, whether a grace period until the nearest inspection time remains within a predetermined period of time; and an extraction part which extracts, when the determination part determines that the grace period remains within the predetermined period of time, all dates on which a reservation for an inspection can be made based on the inspection reservation information, and extracts, in order of smallest to largest scheduled production number, a predetermined number of dates from the extracted reservable dates based on the scheduled production number information.

According to a third aspect of this disclosure, in the production system according to the first aspect or the second aspect, the production management device has an input device for inputting the scheduled production number information, the recommended inspection time information, and the inspection reservation information to the storage part.

According to a fourth aspect of this disclosure, in the production system according to any of the first to third aspects, the extraction part is adapted to display the extracted predetermined number of dates on a display.

### BRIEF DESCRIPTION OF THE DRAWINGS

These objects, features, and advantages of the present invention and other objects, features, and advantages will become further clearer from the detailed description of typical embodiments illustrated in the appended drawings.

FIG. 1 is a block diagram schematically illustrating a production system according to a first embodiment.

FIG. 2 is a view showing an example of scheduled production number information.

FIG. 3 is a view showing an example of recommended inspection time information.

FIG. 4 is a view showing an example of inspection reservation information.

FIG. 5 is a flowchart showing a characteristic process of the production system according to the first embodiment.

FIG. 6 is a view obtained by modeling the process at step S11 in FIG. 5.

FIG. 7 is a view obtained by modeling the processes at steps S13 to S14 in FIG. 5.

FIG. 8 is a block diagram schematically illustrating a production system according to a second embodiment.

### DETAILED DESCRIPTION

Embodiments of the present invention will be described below with reference to the accompanying drawings. In the following figures, similar members or parts which have similar functions are designated with the same reference numerals. These figures are properly modified in scale in order to assist the understanding thereof. Further, the embodiments shown in the drawings are merely examples for carrying out the present invention, and the present invention is not limited to the illustrated embodiments.

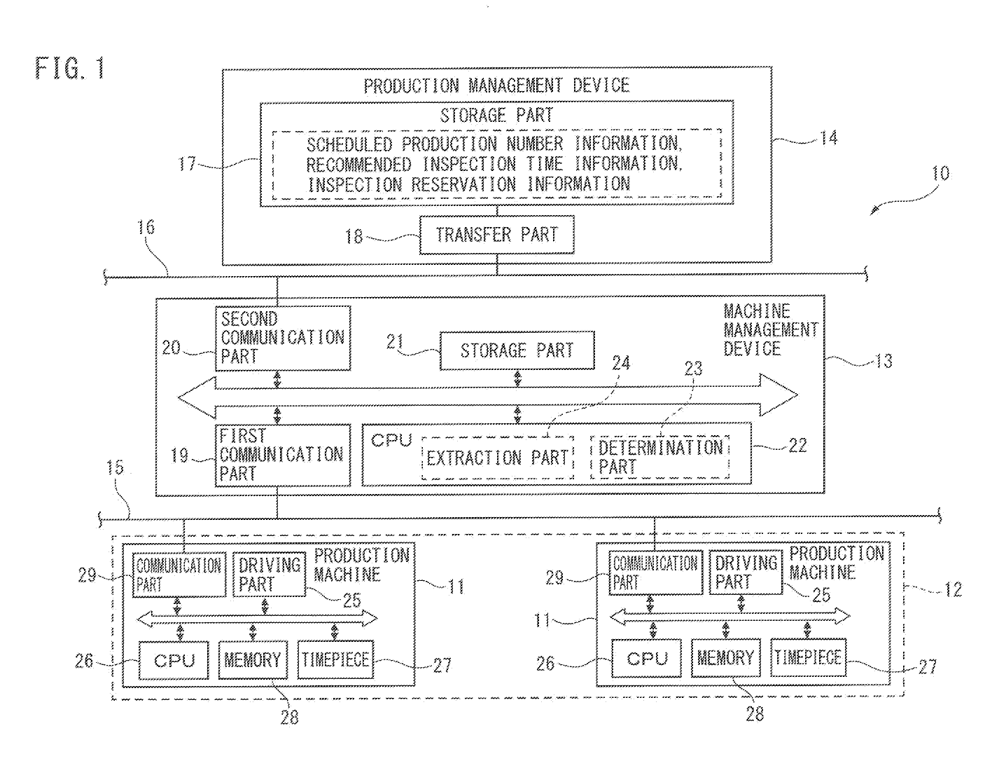

FIG. 1 is a block diagram schematically illustrating a production system 10 according to a first embodiment.

The production system 10 in this embodiment shown in FIG. 1 is a system in which a production cell 12 comprised of a plurality of production machines 11 produces articles.

The production system 10 of the first embodiment includes at least one production cell 12, a machine management device 13, which is communicably connected to a plurality of production machines 11 constituting the production cell 12 so as to manage each production machine 11, and a production management device 14 communicably connected to the machine management device 13.

The production management device 14 is a device, for example, a MES (Manufacturing Execution System) for making a production plan on which the production cell 12 produces products based, and managing the production status in a plurality of the production machines 11 of the production cell 12.

The production cell 12 is a production facility of a cell production system obtained by flexibly combining the production machines 11. Instead of the production cell 12, a production facility of a line production system obtained by flexibly combining a plurality of the production machines 11, i.e., a production line may be applied to the production system 10. In FIG. 1, two production machines 11 construct the production cell 12. However, in the present invention, the number of production facilities such as production cells 12 or production lines, or the number of production machines in each production facility is not limited.

Further, the production facility, such as the production cell 12 or the production line, is not limited to a production facility constructed by only production machines of the same type. The production facility may be constructed by a plurality of different production machines including, for example, an industrial robot, a numerical control working machine, and a PLC (Programmable Logic Controller). Examples of the other production machines to construct the production facility may include a numerical control machine tool, an industrial robot, a measuring instrument, a testing device, a pressing machine, a printing machine, a die-cast machine, an injection molding machine, a food machine, a packaging machine, a welding machine, a washing machine, a painting machine, an assembling device, a mounting machine, a wood working machine, a sealing device, and a cutting machine.

The production cell 12 is disposed in a production factory for, for example, producing articles. The production cell 12 may be provided across production factories in a plurality of buildings. By contrast, the machine management device 13 may be disposed at a building separate from a production factory. In this instance, it is preferable that the machine management device 13 and each production machine 11 in the production cell 12 are communicably connected via a communication network 15, such as an intranet or a LAN.

Further, the production management device 14 may be a host computer (not shown in figures) disposed at, for example, an office distant from a production factory. In this instance, it is preferable that the host computer is configured by a computer on the cloud such as a cloud server and the host computer and the machine management device 13 are communicably connected via a communication network 16 in, for example, the Internet.

As shown in FIG. 1, the production management device 14 of this embodiment has a storage part 17 such as a database, and a transfer part 18 for transferring the information stored in the storage part 17 to the machine management device 13.

The storage part 17 of the production management device 14 previously stores scheduled production number information, recommended inspection time information, and inspection reservation information.

The transfer part 18 automatically transfers each of the scheduled production number information, the recommended inspection time information, and the inspection reservation information, which have been stored in the storage part 17, to the machine management device 13 at every predetermined cycle, or transfers them to the machine management device 13 in accordance with the request from the machine management device 13.

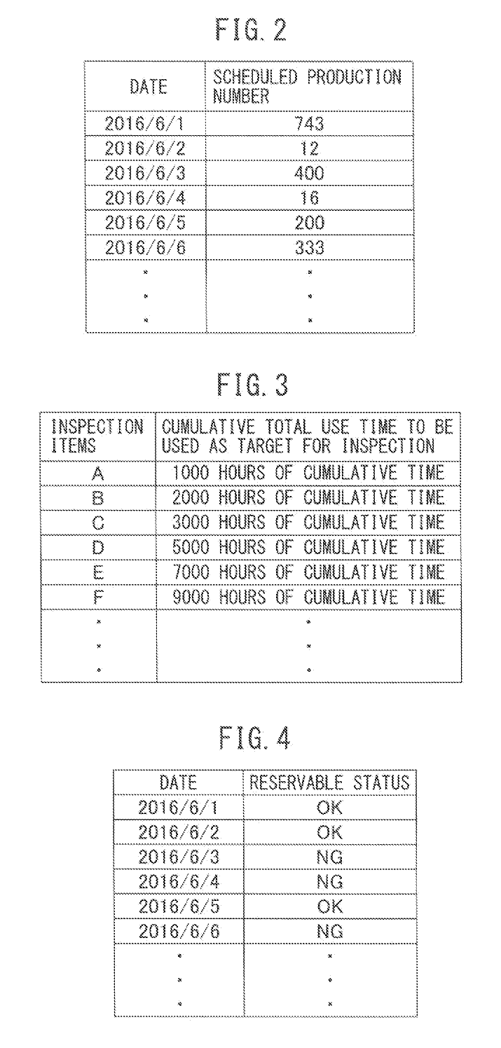

In this respect, FIG. 2 is a view showing an example of the scheduled production number information, FIG. 3 is a view showing an example of the recommended inspection time information, and FIG. 4 is a view showing an example of the inspection reservation information.

The scheduled production number information is, as shown in FIG. 2, information obtained by associating a plurality of consecutive dates with the scheduled production number of products to be produced by a given production machine 11 at every date. The storage part 17 stores, for example, the fact that the scheduled production number of products to be produced by a given production machine 11 on Jun. 1, 2016 is 743, and the scheduled production number of products to be produced by the same production machine 11 on Jun. 2, 2016 is 12. Such scheduled production number information is prepared for each of all the production machines 11 in the production cell 12.

The recommended inspection time information is, as shown in FIG. 3, information obtained by correlating a plurality of inspection items for a given production machine 11 with the inspection time at which each inspection relating to these inspection items should be conducted. The inspection time for each inspection item defines a time which is used as a target for a periodic inspection, and is defined by the cumulative total use time of the production machine 11 at each inspection item, i.e., the elapsed time from the beginning of use of the production machine 11 or a cumulative total of operation time. The storage part 17 stores, for example, the fact that the cumulative total use time to be used as a target for an inspection item A in a given production machine 11 is 1,000 hours, and the cumulative total use time to be used as a target for an inspection item B is 2,000 hours. Such recommended inspection time information is prepared for each of the production machines 11 having different internal configurations.

The inspection reservation information is, as shown in FIG. 4, information obtained by associating a plurality of consecutive dates with the reservable status of the inspection organization at every date. The storage part 17 stores, for example, the fact that a reservation for an inspection can be made on Jun. 1, 2016, and a reservation for an inspection cannot be made on Jun. 2, 2016.

As can be seen from FIGS. 2, 3, and 4, it is preferable that the storage part 17 stores each of the scheduled production number information, the recommended inspection time information, and the inspection reservation information, as a data file in the form of, for example, a table structure.

In this embodiment, it is preferable that an input device (not shown in figures) for inputting data constituting each of the scheduled production number information, the recommended inspection time information, and the inspection reservation information, e.g., date, scheduled production number, etc. to the storage part 17, is connected to the storage part 17. The input device is, for example, a keyboard or a touch panel, i.e., a device for performing a data entry task as well as deletion or rewriting of data.

As shown in FIG. 1, each of the production machines 11, the machine management device 13, and the production management device 14 is configured using a computer system comprised of, for example, a storage part, a CPU (central processing unit), and a communication part, which are connected to one another via bus lines. The storage part is a memory, such as a ROM (read only memory) or a RAM (random access memory).

Further, the function or operation of each of the production machines 11, the machine management device 13, and the production management device 14, which will be described later, is achieved by a program which is stored in each of their ROMs so as to be executed by a CPU. For example, a memory 28 such as a ROM included in each production machine 11 stores a control program for operating the corresponding production machine 11, and a driving part 25 for a motor included in each production machine 11 operates in accordance with the control program executed by a CPU 26.

Each production machine 11 is provided with a timepiece 27. Each production machine 11 has a use time measuring part for measuring an elapsed time from the beginning of use of the production machine 11 by the timepiece 27 in the production machine 11, and for transmitting the elapsed time, as cumulative total use time data, to the machine management device 13. The cumulative total use time data may be a cumulative total of all operation times of the production machine 11.

It is preferable that the CPU 26 embedded in the production machine 11 functions as the use time measuring part. For example, the CPU 26 in the production machine 11 can read out a time at which the production machine 11 arranged in a factory is initially operated from the timepiece 27 so as to store the time in the memory 28, and can calculate how many hours elapsed from the time to the present time so as to output the calculated hours to a communication part 29.

It is preferable that such a use time measuring part is configured to start acquiring cumulative total use time data upon receiving an external signal for starting measuring a time. This use time measuring part may be included in the machine management device 13.

Further, the configuration of the machine management device 13 described above will be described in detail.

As shown in FIG. 1, the machine management device 13 of this embodiment includes a first communication part 19, a second communication part 20, a storage part 21, and a CPU 22 for controlling these parts. The CPU 22 functions as a determination part 23 and an extraction part 24. The machine management device 13 of this embodiment manages the production cell 12, and accordingly, is also referred to as a cell controller.

The first communication part 19 has a function for communicating with the communication part 29 of each production machine 11 in the production cell 12 in order to deliver and receive information. For example, the first communication part 19 transmits operation commands to the corresponding production machines 11 in the production cell 12 via the communication network 15. The first communication part 19 receives, from each production machine 11 in the production cell 12, the state of the production machine 11 operated based on the operation command, e.g., the position, speed, torque, etc. of the driving part such as a motor. Further, the first communication part 19 can receive the cumulative total use time data of each production machine 11.

The second communication part 20 has a function for communicating with the production management device 14 in order to deliver and receive information. In particular, the second communication part 20 of this embodiment receives the scheduled production number information, the recommended inspection time information, and the inspection reservation information, which have been stored in the storage part 17 of the production management device 14, from the transfer part 18 of the production management device 14 via the communication network 16.

The storage part 21 stores the cumulative total use time data of each production machines 11, which have been received by the first communication part 19, and the scheduled production number information, the recommended inspection time information, and the inspection reservation information, which have been received by the second communication part 20.

The storage part 21 includes a ROM and a RAM. The ROM stores a program and an algorithm, which cause the CPU 22 to function as the determination part 23 and the extraction part 24, which will be described later. The RAM has a storage capacity that is sufficient to cause the CPU 22 to perform a calculation in accordance with the program and algorithm.

The determination part 23 determines, using the cumulative total use time data and the recommended inspection time information of the production machine 11, whether the grace period until the nearest inspection time for the production machine 11 remains within a predetermined period of time. The determination of whether the grace period remains within a predetermined period of time is performed for every production machine 11. In other words, the determination part 23 determines, for each production machine 11, whether the time in which a periodic inspection should be conducted is close. Such a function is realized by the CPU 22 and the algorithm in the storage part 21.

When the determination part 23 determines that the grace period remains within a predetermined period of time in any of the production machines 11, the extraction part 24 extracts, all dates on which a reservation for an inspection can be made, from the inspection reservation information. Further, the extraction part 24 extracts predetermined number of dates from the extracted reservable dates in order of smallest to largest scheduled production number based on the scheduled production number information of the production machine 11. Such a function is realized by the CPU 22 and the algorithm in the storage part 21.

Further, the extraction part 24 is adapted to display a predetermined number of dates extracted as described above on a display. It is preferable that the display is, for example, a display device or a printing device (not shown in figures), which is connected to each production machine 11, the machine management device 13, or the production management device 14.

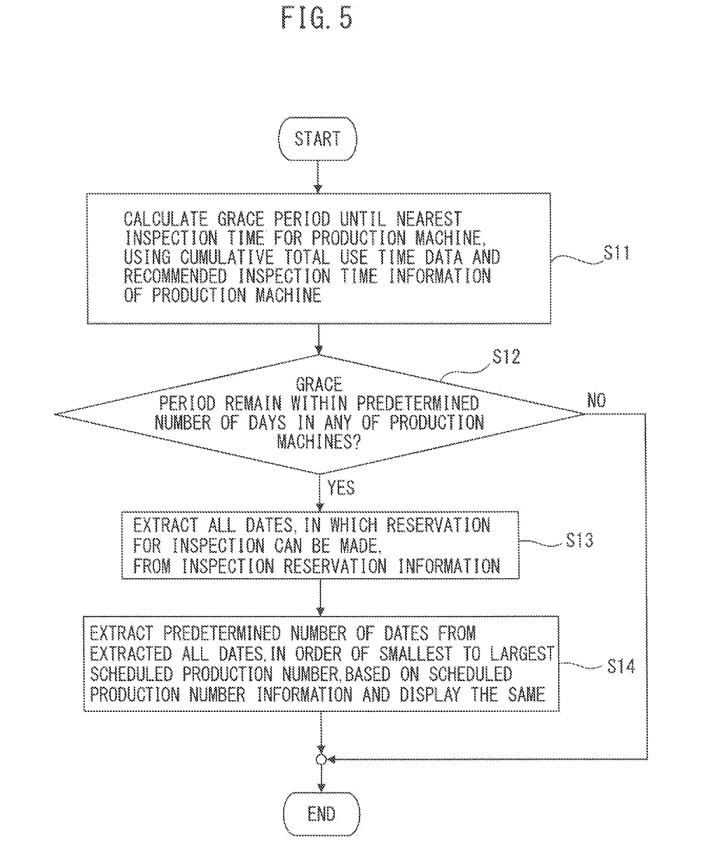

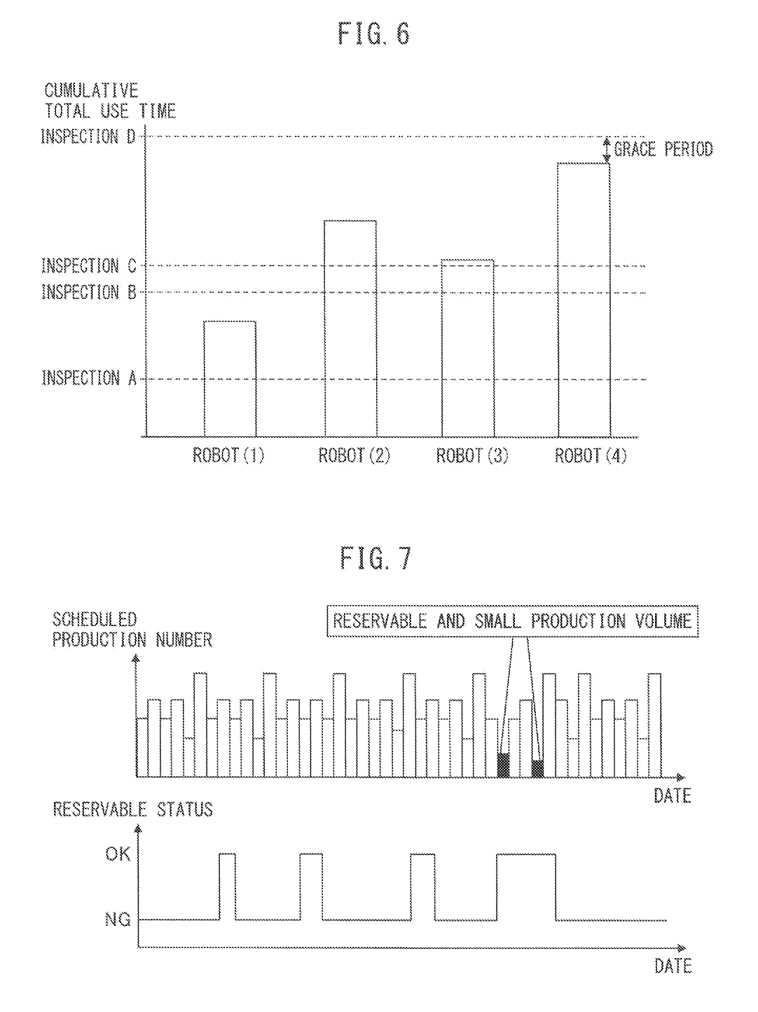

FIG. 5 is a flowchart showing a characteristic process in the production system 10 of this embodiment. FIG. 6 is a view obtained by modeling the process at step S11 in FIG. 5. FIG. 7 is a view obtained by modeling the processes at steps S13 to S14 in FIG. 5.

The characteristic process in the production system 10 of this embodiment will be described below with reference to FIGS. 5 to 7.

Before the beginning of the process shown in FIG. 5, the scheduled production number information, the recommended inspection time information, and the inspection reservation information of each of the production machines 11 are transferred from the production management device 14 to the machine management device 13. Further, the machine management device 13 continues to receive the cumulative total use time data from each of the production machines 11.

First, at step S11 in FIG. 5, the determination part 23 of the machine management device 13 calculates, for every production machine 11, using the cumulative total use time data and the recommended inspection time information of a given production machine 11, a grace period until the nearest inspection time for the production machine 11.

More specifically, as shown in FIG. 6, the present cumulative total use time of each of the production machines 11 is clearly understood by expressing the cumulative total use time data of each of the production machines 11 (e.g., robots (1) to (4)), which have been transmitted from the machine management device 13, in the form of a vertical bar graph. Further, as shown by lateral dashed lines in FIG. 6, the cumulative total use time to be used as a target for each of a plurality of inspection items (inspections A to D) for each of the production machines 11 is understood from the recommended inspection time information transmitted to the machine management device 13 (see FIG. 3). Thus, regarding, for example, the robot (4) shown in FIG. 6, the grace period from the present cumulative total use time of the robot (4) until the cumulative total use time to be used as a target for the inspection item (inspection D) that will be conducted at the nearest inspection time, can be found.

Note that, in FIG. 6, the robots (1) to (4) are the production machines 11 having the same internal configuration, and accordingly, the recommended inspection time information is common to all the robots.

Subsequently, at step S12 in FIG. 5, the determination part 23 determines, in any of the production machines 11, whether the above-described grace period remains within a predetermined period of time. It is preferable that the predetermined period of time can be previously and freely set.

At step S12 described above, when the fact that the grace period is out of a predetermined period of time is determined in either of the production machines 11, this process ends.

In the meantime, at step S12, when the fact that the grace period remains within a predetermined period of time is determined in either of the production machines 11, step S13 in FIG. 5 is conducted.

At step S13, the extraction part 24 of the machine management device 13 extracts all dates, on which a reservation for an inspection can be made, from the inspection reservation information.

Further, at step S14 in FIG. 5, the extraction part 24 extracts, in order of smallest to largest scheduled production number, a predetermined number of dates from the extracted reservable dates based on the scheduled production number information of the production machine 11 for which the fact that the grace period remains within a predetermined period of time is determined, and displays the dates on a display (not shown in figures). When a predetermined number of dates on which the scheduled production number is small are displayed on the display, this process ends.

More specifically, based on the inspection reservation information (see FIG. 4) transferred to the machine management device 13, the reservable status (OK or NG) of an inspection for each of consecutive dates can be represented as in the lower view of FIG. 7. Further, based on the scheduled production number information (see FIG. 2) of the production machine 11 in which the grace period remains within a predetermined period of time, the scheduled production number for each of consecutive dates in the production machine 11 can be represented as in the upper view of FIG. 7. Two pieces of information represented in the upper and lower views of FIG. 7 enable all dates, on which a reservation for an inspection can be made, to be extracted from a plurality of consecutive dates, and enable a predetermined number of dates to be extracted from the extracted reservable dates in order of smallest to largest scheduled production number, and then to be displayed. In other words, as shown in the upper view of FIG. 7, dates, on which the reservation can be made and small production volume is planned, can be distinguished from the other dates, and can be displayed for the user.

It is preferable that the process (step S11 to step S14) is performed at a predetermined cycle. Further, the start command for the process may be generated from any of the production machines 11, the machine management device 13, and the production management device 14.

Further, when the fact that the grace period remains within a predetermined period of time is determined for a plurality of production machines 11 at step S12, it is preferable that the processes at steps S13 and S14 are performed for each of the production machines 11. Thus, regarding a plurality of production machines 11 which have an inspection item to be most shortly conducted, the user can recognize a plurality of dates, on which a reservation for an inspection can be made and the production volume is small. Thus, the user can collectively inspect the production machines 11 having the nearest inspection dates.

Further, it is preferable that each production machine 11 includes an input unit, e.g., an operation board for inputting the latest inspection item and its inspection date to the memory 28. Furthermore, it is preferable that the extraction part 24 also reads the latest inspection item and its inspection date from the memory 28 of each production machine 11, and displays them on the display when displaying a plurality of dates, on which a reservation for an inspection can be made and the production volume is small, on the display. By adopting this configuration, the user can recognize the inspection items that have not been conducted in the past in each production machine 11.

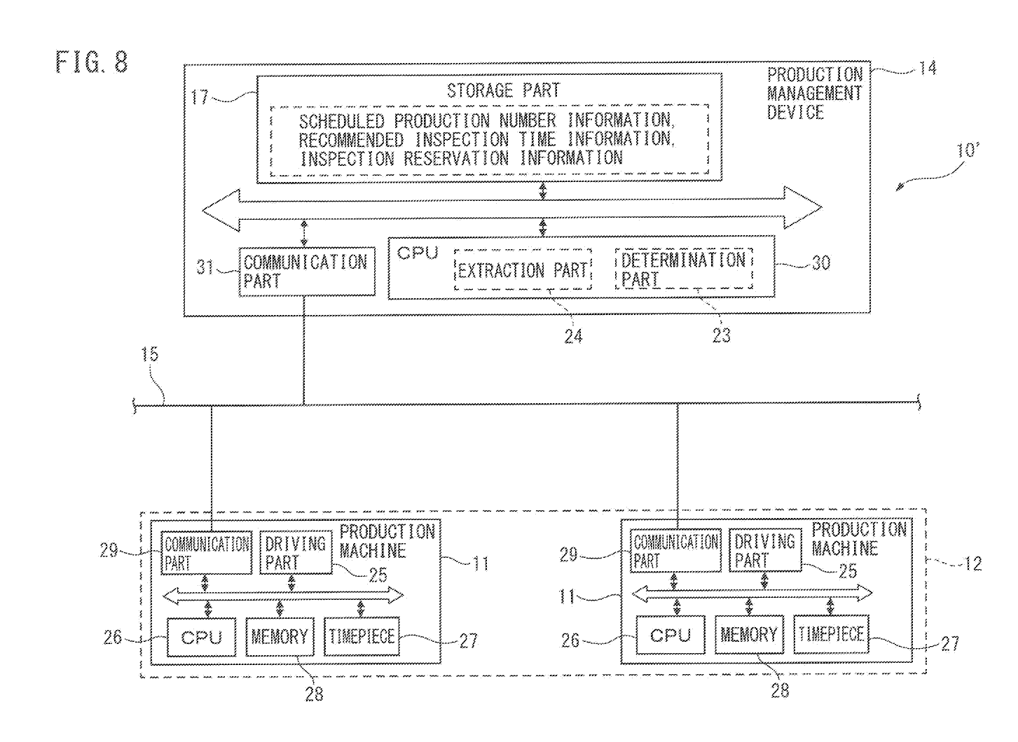

FIG. 8 is a block diagram schematically illustrating a production system 10′ according to a second embodiment. The production system 10′ according to the second embodiment will be described below with reference to FIG. 8. Note that the difference with the production system 10 of the first embodiment will be mainly described below. Further, in the production system 10′ shown in FIG. 8, the components similar to those of the production system 10 of the first embodiment are designated by the same reference numerals.

As shown in FIG. 8, the production system 10′ of the second embodiment includes a plurality of production machines 11 which constitute at least one production cell 12 and a production management device 14 which is communicably connected to the production machines 11 so as to manage the production status in each production machine 11. The fact that the machine management device 13 is not provided between the production management device 14 and the production machines 11 is a difference with the production system 10 of the first embodiment.

The production management device 14 of the second embodiment also has a storage part 17, a CPU 30 functioning as a determination part 23 and an extraction part 24, and a communication part 31.

The functions of the storage part 17, the determination part 23, and the extraction part 24 are identical to those of the first embodiment.

The communication part 31 has a function for communicating with the communication part 29 of each production machine 11 in the production cell 12 in order to deliver and receive information. For example, the communication part 31 transmits operation commands to the corresponding production machines 11 in the production cell 12 via the communication network 15. The communication part 31 receives, from each production machine 11 in the production cell 12, the state of the production machine 11 operated based on the operation command, e.g., the position, speed, torque, etc. of the driving part 25 such as a motor. Further, the communication part 31 can receive the cumulative total use time data measured by a use time measuring part of each production machine 11. The use time measuring part may be included in the production management device 14.

In the production system 10′ of the second embodiment, a predetermined number of dates on which production volume is small and which are convenient for the production organization can be extracted by the extraction part 24, and can be displayed for the user in the same way as the production system 10 of the first embodiment. It is preferable that the extraction part 24 displays a predetermined number of dates that have been extracted as described above, on a display. It is preferable that the display is, for example, a display device or a printing device (not shown in figures) connected to the production management device 14 or each production machine 11. Additionally, the configuration or function applicable to the production system 10 of the first embodiment can also be applied to the production system 10 of the second embodiment.

According to the above-described production system of the first embodiment and the second embodiment, it can be determined whether the time in which a periodic inspection is conducted approaches for each of the production machines 11 based on the cumulative total use time data of each production machine 11 and the recommended inspection time information. Further, regarding date of inspection of the production machine 11 for which the fact that the time for conducting a periodic inspection is close is determined, a date on which a small production volume is planned and which is convenient for the production organization, can be extracted and submitted based on the scheduled production number of the production machine 11 at every date and the reservable status of the inspection organization.

This can support preventive maintenance, such as periodic inspection, periodic replacement of parts, etc. Further, a periodic inspection can be conducted at a time having a small production volume, and accordingly, the production opportunity loss is reduced. Thus, the user can previously advantageously adjust the inspection schedule of the inspection organization.

The present invention has been described above using exemplary embodiments. However, a person skilled in the art would understand that the aforementioned modifications and various other modifications, omissions, and additions can be made without departing from the scope of the present invention.

According to the first aspect and the second aspect of this disclosure, it can be determined whether the time for conducting a periodic inspection in each production machine is coming. Regarding date of inspection of the production machine for which the fact that the time is coming to conduct a periodic inspection is determined, a date on which a small production volume is planned and which is convenient for the production organization can be submitted.

Further, according to the third aspect of this disclosure, the scheduled production number information, the recommended inspection time information, and the inspection reservation information can be added by the input device.

Furthermore, according to the fourth aspect of this disclosure, the display enables the user to easily understand a date on which a small production volume is planned and which is convenient for the production organization.

1. A production system comprising:
at least one production machine;
a machine management device which is communicably connected to the production machine and manages the production machine; and
a production management device which is communicably connected to the machine management device and manages a production status in the production machine, wherein
the production machine has a use time measuring part for acquiring, as cumulative total use time data, an elapsed time from the beginning of use of the production machine or a cumulative operation time, and transmitting the same to the machine management device,
the production management device has:
a storage part which stores scheduled production number information obtained by associating a plurality of consecutive dates with a scheduled production number in each production machine at every date, recommended inspection time information obtained by associating a plurality of inspection items in each production machine with an inspection time at which an inspection of the inspection items should be conducted, and inspection reservation information obtained by associating a plurality of consecutive dates with a reservable status of an inspection organization at each of these dates; and
a transfer part which transfers the scheduled production number information, the recommended inspection time information, and the inspection reservation information from the storage part to the machine management device, and
the machine management device has:
a determination part which determines, using the cumulative total use time data of each production machine and the recommended inspection time information, whether a grace period until the nearest inspection time remains within a predetermined period of time; and
an extraction part which extracts,
when the determination part determines that the grace period remains within the predetermined period of time, all dates on which a reservation for an inspection can be made based on the inspection reservation information, and extracts, in order of smallest to largest scheduled production number, a predetermined number of dates from the extracted reservable dates based on the scheduled production number information.

2. A production system comprising:
at least one production machine; and
a production management device which is communicably connected to the production machine and manages a production status in the production machine, wherein
the production machine has a use time measuring part for acquiring, as cumulative total use time data, an elapsed time from the beginning of use of the production machine or a cumulative operation time, and transmitting the same to the machine management device, and
the production management device has:
a storage part which stores scheduled production number information obtained by associating a plurality of consecutive dates with a scheduled production number in each production machine at every date, recommended inspection time information obtained by associating a plurality of inspection items in each production machine with an inspection time at which an inspection of the inspection items should be conducted, and inspection reservation information obtained by associating a plurality of consecutive dates with a reservable status of an inspection organization at each of these dates;
a determination part which determines, using the cumulative total use time data of each production machine and the recommended inspection time information, whether a grace period until the nearest inspection time remains within a predetermined period of time; and
an extraction part which extracts, when the determination part determines that the grace period remains within the predetermined period of time, all dates on which a reservation for an inspection can be made based on the inspection reservation information, and extracts, in order of smallest to largest scheduled production number, a predetermined number of dates from the extracted reservable dates based on the scheduled production number information.

3. The production system according to claim 1, wherein the production management device has an input device for inputting the scheduled production number information, the recommended inspection time information, and the inspection reservation information to the storage part.

4. The production system according to claim 1, wherein the extraction part is adapted to display the extracted predetermined number of dates on a display.
